(19) United States
(12) Patent Application Publication
(10) Pub. No.: US 2025/0197037 A1
(43) Pub. Date: Jun. 19, 2025

(54) RE-USABLE INTERCEPT DRONE, DRONE ENGAGEMENT SYSTEM AND METHOD THEREFOR

(71) Applicant: MARSS Ventures Ltd, Ta’ Xbiex (MT)

(72) Inventor: Stephen SCOTT, Bristol (GB)

(73) Assignee: MARSS Ventures Ltd, Ta’ Xbiex (MT)

(21) Appl. No.: 18/843,955

(22) PCT Filed: Mar. 3, 2023
(86) PCT No.: PCT/EP2023/055519

§ 371 Date: Sep. 4, 2024

(30) Foreign Application Priority Data
Mar. 4, 2022 (GB) 2203043.1

(51) Int. Cl. B64U 10/25; B64F 5/60; B64U 20/60; B64U 50/12; B64U 101/16; G05D 1/683; G05D 105/35; G05D 109/22

(52) U.S. Cl. CPC B64U 10/25; B64F 5/60; B64U 20/60; B64U 50/12; G05D 1/683; B64U 2101/16; G05D 2105/35; G05D 2109/22

(57) ABSTRACT

A re-usable intercept drone (104) comprises an elongate fuselage (200), a first wing (202) and a second wing (206) operably coupled to the elongate fuselage (200) and extending substantially away from the elongate fuselage (200). A first propulsion unit (210) and a second propulsion unit (212) are operably coupled to the first wing (202) and the second wing (206), respectively. A third propulsion unit (214) and a fourth propulsion unit (218) are operably coupled to the fuselage (200). The first, second, third and fourth propulsion units (210, 212, 214, 218) are circumferentially spaced about the elongate fuselage (200).

The present invention relates to a re-usable intercept drone of the type that, for example, comprises a plurality of power units. The present invention also relates to a drone engagement system of the type that, for example, receives an identity of a target to be engaged and instructs an intercept drone to collide with the target. The present invention also relates to a method of engaging a target, the method being of the type that, for example, comprises receiving an identity of a target to be engaged and instructing an intercept drone to collide with the target.

In the field of Unmanned Aerial Vehicles (UAVs), it is known to encounter nuisance airborne vehicles, for example so-called “drones” that are discovered in locations where they are unwanted and/or unauthorised. For example, in the context of a flying drone, airspace at or close to an airport may contain an unauthorised drone that has been intentionally or accidentally flown into the airspace of the airport.

Owing to the cost and undesirability of deploying certain classes of military weapon, for example a missile, it is known to deploy a drone and attempt to collide with an unauthorised target drone. However, such offensive drones suffer from a number of drawbacks, including insufficient speed, strength and manoeuvrability.

According to a first aspect of the present invention, there is provided a re-usable intercept drone comprising: an elongate fuselage; a first wing and a second wing operably coupled to the elongate fuselage and extending substantially away from the elongate fuselage; a first propulsion unit and a second propulsion unit operably coupled to the first wing and the second wing, respectively; and a third propulsion unit and a fourth propulsion unit operably coupled to the fuselage; wherein the first, second, third and fourth propulsion units are circumferentially spaced about the elongate fuselage.

The re-usable intercept drone may be airborne.

At least one of the first, second, third and fourth propulsion units may be a ducted fan propulsion unit.

At least one of the first, second, third and fourth propulsion units may be a shrouded prop propulsion unit.

The drone may further comprise: a plurality of leading edges relative to an intended direction of travel; wherein a number of the plurality of leading edges may be reinforced.

The fuselage may comprise a nose cone portion; the nose cone portion may comprise a reinforcement structure.

The nose cone may comprise a ram constituting the reinforcement structure.

The ram may be formed from aluminium.

The reinforcement may be material-based.

The reinforcement may be a coating of a material.

The coating may be a metallic coating. The metallic coating may be a titanium coating.

The drone may further comprise: a plurality of sensor modules configured to generate a plurality of data; a processing resource; wherein the plurality of sensor modules may be operably coupled to the processing resource and the processing resource may be configured to detect damage sustained by the drone in response to one or more data received from one of more of the plurality of sensors, respectively.

According to a second aspect of the present invention, there is provided a drone engagement system comprising: a plurality of re-usable intercept drones as set forth above in relation to the first aspect of the present invention; and a control system; wherein the control system is configured to communicate with the plurality of re-usable intercept drones, and the plurality of re-usable intercept drones is configured to communicate with the control system; the control system is configured to receive an identity of a target; the control system is configured to plan one or more collisions of the plurality of intercept drones with the target; and the control system is configured to communicate the identity of the target and a location to the plurality of re-usable intercept drones in accordance with the planned one or more collisions.

The control system may be configured to coordinate the one or more collisions of a number of the plurality of intercept drones with the target.

The control system may be configured to choreograph the one or more collisions of a number of the plurality of intercept drones with the target.

According to a third aspect of the present invention, there is provided a drone engagement system comprising: a re-usable intercept drone as set forth above in relation to the first aspect of the present invention; and a control system; wherein the control system is configured to communicate with the re-usable intercept drone, and the re-usable intercept drone is configured to communicate with the control system; the control system is configured to identify a target to the re-usable intercept drone and instruct the re-usable intercept drone to collide with the target.

The control system may be ground based. The control system may be peer-to-peer.

The control system may be configured to interrogate the re-usable intercept drone to determine a degree of flightworthiness of the re-usable intercept drone after an attempted collision of the re-usable intercept drone with the target.

The control system may be configured to identify another target to the re-usable intercept drone in response to the degree of flightworthiness being acceptable to continue missions, and to instruct the re-usable intercept drone to collide with the another target.

The control system may be configured to instruct the re-usable intercept drone to land at a predetermined location in response to the degree of flightworthiness being unacceptable to continue missions.

According to a fourth aspect of the present invention, there is provided a method of colliding a re-usable intercept drone with a target, the method comprising: a control system communicating an identity of the target to the re-usable intercept drone; and the control system instructing the re-usable intercept drone to collide with the target.

The re-usable intercept drone may attempt to collide with the target; and the control system may communicate with the re-usable intercept drone to determine a degree of flightworthiness of the re-usable intercept drone after the attempted collision.

The control system may communicate an identity of another target to the re-usable intercept drone in response to the degree of flightworthiness being acceptable to continue missions.

The control system may instruct the re-usable intercept drone to land at a predetermined location in response to the degree of flightworthiness being unacceptable to continue missions.

According to a fifth aspect of the present invention, there is provided a method of controlling engagement of a plurality of re-usable intercept drones with a target, the method comprising: a control system receiving an identity of a target; the control system planning one or more collisions of the plurality of re-usable intercept drones with the target; and the control system communicating the identity of the target and a location thereof to the plurality of re-usable intercept drones in accordance with the planned one or more collisions.

According to a sixth aspect of the invention, there is provided a re-usable intercept drone comprising: an elongate fuselage; a first wing and a second wing operably coupled to the elongate fuselage and extending substantially away from the elongate fuselage; a first propulsion unit and a second propulsion unit operably coupled to the first wing and the second wing, respectively; and a third propulsion unit operably coupled to the fuselage; wherein the first, second and third propulsion units are equally spaced therebetween.

It is thus possible to provide an apparatus, method and system that provide an effective manner of intercepting a target drone, such that the target drone can be destroyed, and the intercept drone can often be reused as a result of the structural strength of the intercept drone. The intercept drone is cost-effective to employ owing to the reusability of the intercept drone. The intercept drone is also faster and more manoeuvrable than traditional quadcopter type drones.

At least one embodiment of the invention will now be described, by way of example only, with reference to the accompanying drawings, in which:

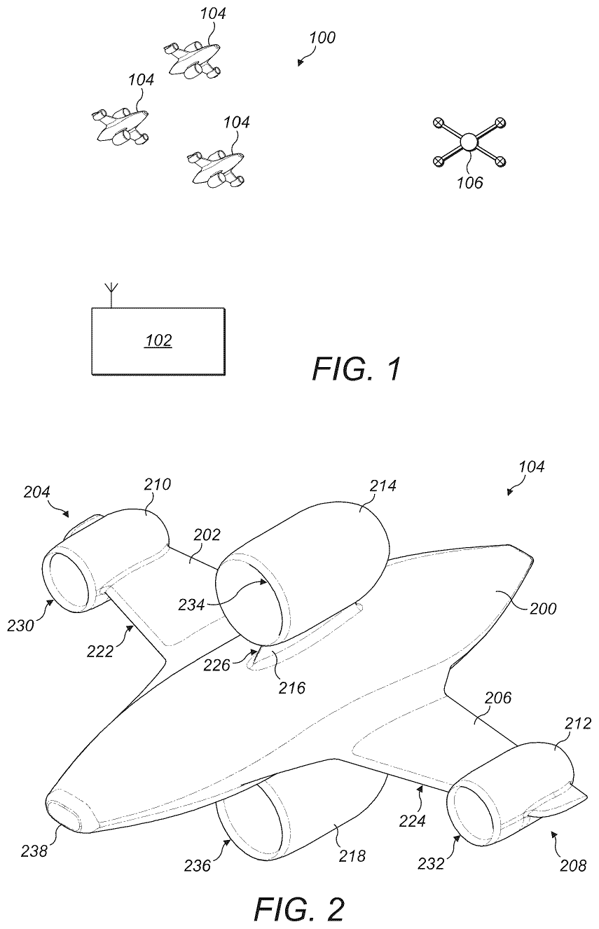

FIG. 1 is a schematic diagram of a drone engagement system constituting an embodiment of the invention;

FIG. 2 is a perspective schematic diagram of a re-usable intercept drone of FIG. 1 and constituting another embodiment of the invention;

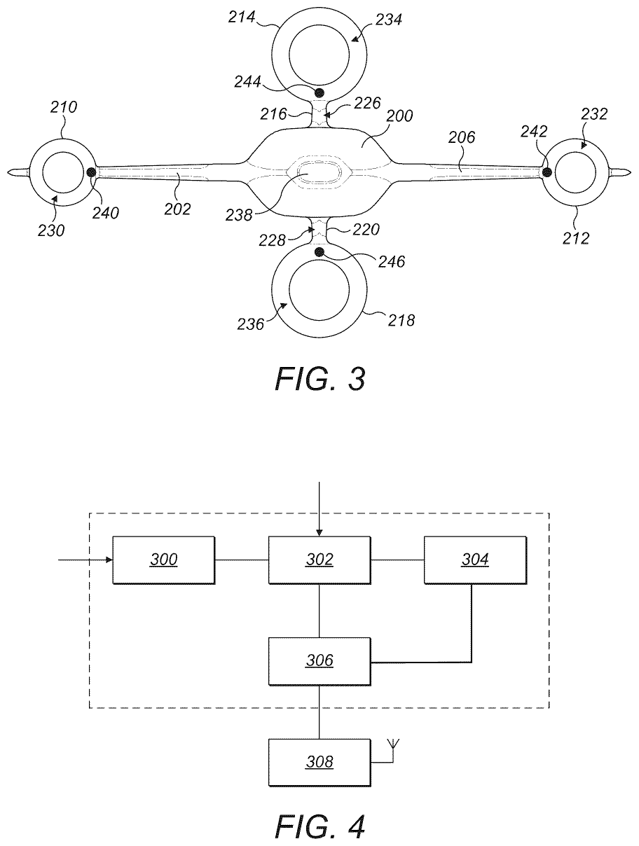

FIG. 3 is a front elevation of the re-usable intercept drone of FIG. 2;

FIG. 4 is a schematic diagram of a control system of the drone engagement system of FIG. 3 and constituting a further embodiment of the invention;

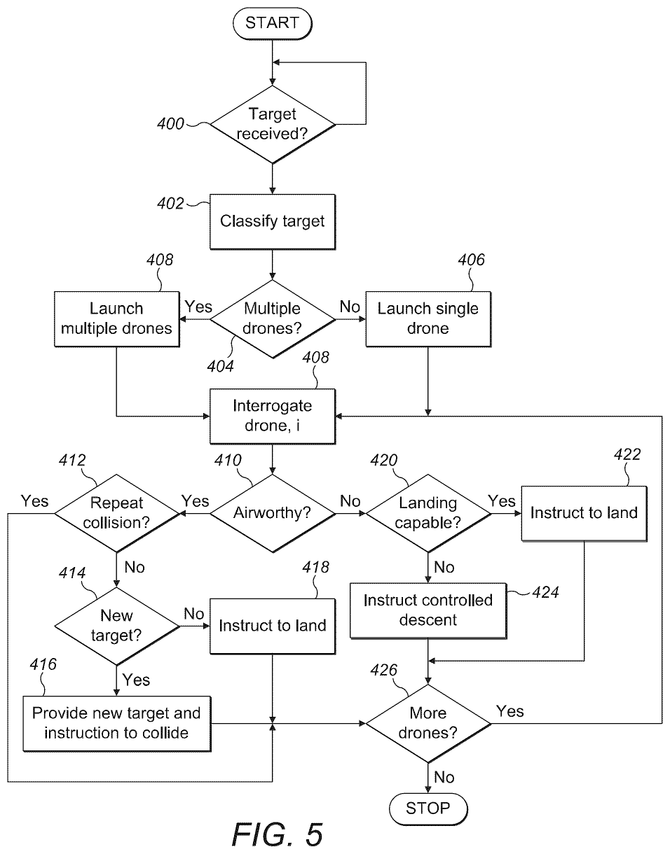

FIG. 5 is a flow diagram of a method of colliding a re-usable intercept drone with a target constituting another embodiment of the invention; and

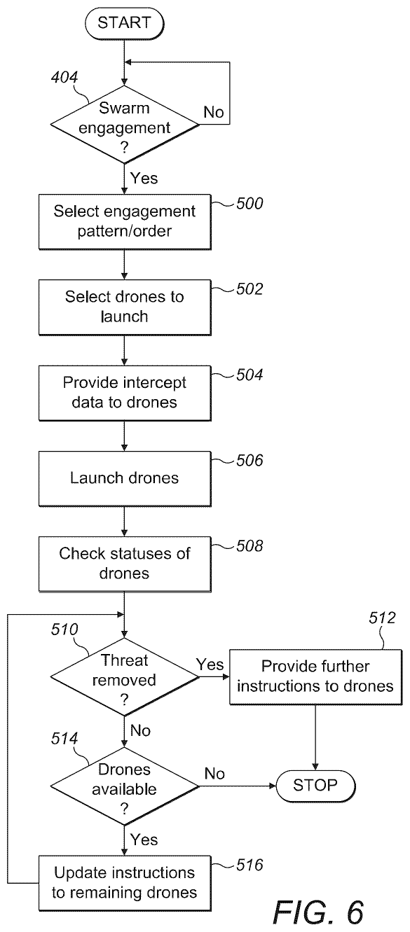

FIG. 6 is a flow diagram of a method of controlling engagement of a plurality of re-usable intercept drones with a target.

Throughout the following description, identical reference numerals will be used to identify like parts.

Referring to FIG. 1, a drone engagement system 100 comprises a control system 102 capable of communicating bidirectionally with a plurality of re-usable intercept drones 104. In this example, the re-usable intercept drones are en route to intercept an unauthorised Unmanned Aerial Vehicle (UAV) 106.

Turning to FIGS. 2 and 3, a re-usable intercept drone 104 comprises an elongate fuselage 200 having a generally prolate spheroid shape. A first fixed wing 202 extends from a first side 204 of the elongate fuselage 200 and a second fixed wing 206 extends from a second, opposite, side 208 of the fuselage 200, the first and second wings 202, 206 extending away from the elongate fuselage 200.

A first propulsion unit 210, for example a ducted fan propulsion unit, is operably coupled to the first fixed wing 202 towards a distal end thereof with respect to the fuselage 200. A second propulsion unit 212, for example a ducted fan propulsion unit, is operably coupled to the second fixed wing 206 towards a distal end thereof with respect to the fuselage 200.

A third propulsion unit 214, for example a ducted fan propulsion unit, is operably coupled to an upper portion of the fuselage 200 by a first connecting fin 216 and a fourth propulsion unit 218 for example a ducted fan propulsion unit, is operably coupled to a lower portion of the fuselage 200 by a second connecting fin 220 (not shown in FIG. 2).

The first, second, third and fourth propulsion units 210, 212, 214, 218 are circumferentially spaced about the fuselage 200, the first, second, third and fourth propulsion units 210, 212, 214, 218 being angularly spaced about a longitudinal axis (not shown) of the fuselage 200. In this example, the first and second propulsion units 210, 212 are 180° in opposition with respect to each other and the third and fourth propulsion units 214, 216 are also 180° in opposition with respect to each other, the first, second, third and fourth propulsion units 210, 212, 214, 218 being disposed at 90° intervals about the fuselage 200 relative to the longitudinal axis thereof.

Although the first, second, third and fourth propulsion units 210, 212, 214, 218 are ducted fan propulsion units, the skilled person should appreciate that other types of propulsion units can be employed, for example, shrouded prop propulsion units. Indeed, the number of propulsion units employed can also be varied and a greater or smaller number of propulsion units can be employed. Similarly, although the propulsion units are disposed equidistantly about the fuselage, either angularly or by circumferential spacing, the skilled person should appreciate that the spacing between neighbouring propulsion units need not be the same for all propulsion units.

Although not shown, the re-usable intercept drone 104 comprises a power source, for example a battery and control hardware and software, including a communications unit, to receive destination information and control flight of the re-usable intercept drone 104.

In this example, the re-usable intercept drone comprises a plurality of leading edges, for example the first and second fixed wings 202, 206 comprise respective first and second leading edges 222, 224. Likewise, the first and second connecting fins 216, 220 comprise respective third and fourth leading edges 226, 228, and the first, second, third and fourth propulsion units 210, 212, 214, 218 each comprise respective fifth, sixth, seventh and eighth leading edges 230, 232, 234, 236. The leading edges 222, 224, 226, 228, 230, 232, 234, 236 are leading with respect to an intended direction of travel of the re-usable intercept drone 104.

In this example, one or more of the leading edges 222, 224, 226, 228, 230, 232, 234, 236 are reinforced, either through formation of the leading edges with a strengthened material or stronger material than other parts from which of the re-usable intercept drone 104 is formed, or by coating one or more of the leading edges 222, 224, 226, 228, 230, 232, 234, 236, for example with a metal, such as titanium, or any other suitable strengthening coating.

The fuselage 200 comprises a nose cone portion 238, which also constitutes a leading edge, that can also be coated with a strengthening material and/or formed from a stronger material than other parts of the re-usable intercept drone 104 in a like manner to the leading edges 222, 224, 226, 228, 230, 232, 234, 236 described above. Furthermore, the nose cone portion 238 can be mechanically reinforced by provision of a reinforcing structure (not shown) within the fuselage 200 adjacent the nose cone portion 238. The mechanical reinforcement can include a ram structure (not shown) for ramming a target UAV. In this example, the ram is formed from aluminium, although other materials can be employed.

In order to be able to assess airworthiness of the re-usable intercept drone 104, the re-usable intercept drone 104 comprises a plurality of sensors in order to measure flight-related parameters of the re-usable intercept drone 104, for example functionality of the propulsion units 210, 212, 214, 218, velocity compared to expected velocity, fidelity of manoeuvrability and/or physical damage to the airframe of the re-usable intercept drone 104. Temperature sensors, motion sensors, stress sensors and/or inertial sensors are examples of the kinds of sensors that can be employed. In this example (FIG. 3), a first motion sensor 240, a second motion sensor 242, a third motion sensor 244 and a fourth motion sensor 246 are respectively disposed within the first propulsion unit 210, the second propulsion unit 212, the third propulsion unit 214 and the fourth propulsion unit 218 in order to monitor operation of the first, second, third and fourth propulsion units 210, 212, 214, 218. Of course, as explained above, other motion sensors can additionally or alternatively be employed. However, for the sake of clarity and conciseness of description, only the first, second, third and fourth sensors 240, 242, 244, 246 will be mentioned herein.

The control hardware of the re-usable intercept drone 104 described above also comprises a processing resource (not shown), for example a microprocessor, operably coupled to the first, second, third and fourth sensors 240, 242, 244, 246. In this example, one or more data derived from the first, second, third and fourth sensors 240, 242, 244, 246 is communicated to the control system 102 in order to determine airworthiness of the re-usable intercept drone 104. However, in other examples, the processing resource is configured to detect damage sustained by the re-usable intercept drone 104 in response to one or more data received from one of more of the first, second, third and fourth sensors 240, 242, 244, 246. The damage detected by the processing resource can then be communicated to the control system 102.

Referring to FIG. 4, the control system 102 is, in this example, implemented using a computing apparatus, for example a Personal Computer (PC) or any other suitable computing platform. The control system 102 comprises an intercept type processing unit 300 configured to receive a location of a target to be intercepted and optionally a type (if the information is available) of target to be intercepted, for example via an input device, such as a keyboard (not shown) or an intelligent detection system, for example a radar-based surveillance system interfaced with the control system 102. The intercept type processing unit 300 is operably coupled to a drone coordination unit 302, the drone coordination unit 302 being capable of receiving drone availability data from a database (not shown) of available re-usable intercept drones as well as target status information, for example whether a target remains airborne. The drone coordination unit 302 is operably coupled to a drone health unit 304 and a resource control unit 306, the resource control unit 306 also being operably coupled to the drone health unit 304. The resource control unit 306 is further operably coupled to a communication unit 308 for communication with the re-usable intercept drones 104.

In operation (FIGS. 5 and 6), the drone engagement system 100 is provided with a location and type of the unauthorised UAV 106, for example via keyboard input or by receipt of data from a detection/surveillance system (not shown) as described above. Once the target information has been received (Step 400) by the intercept type processing unit 300, the intercept type processing unit 300 attempts to classify (Step 402) the unauthorised UAV 106, for example to determine the size of the target and number of re-usable intercept drones 104 that may be required to render the unauthorised UAV 106 unusable. The classification is communicated to the drone coordination unit 302 and in the event that it has been determined (Step 404) that a single re-usable intercept drone 104 is likely to be sufficient, the drone coordination unit 302 selects a re-usable intercept drone 104 from a plurality of available re-usable intercept drones 104 and communicates the last known location of the unauthorised UAV 106 and the re-usable intercept drone 104 selected to the resource control unit 306, along with an instruction to launch the selected re-usable intercept drone 104. Thereafter, the resource control unit 306, via the communications unit 308, instructs (Step 406) the selected re-usable intercept drone 104 to launch and fly to the location provided.

Similarly, in the event that it has been determined (Step 404) that multiple re-usable intercept drones are required to render the unauthorised UAV 106 unusable, the drone coordination unit 302 selects a number of the re-usable intercept drones from a plurality of available re-usable intercept drones 104 according to the number of drones determined by the intercept type processing unit 300, and communicates the last known location of the unauthorised UAV 106 and the re-usable intercept drones 104 selected to the resource control unit 306, along with an instruction to launch the selected re-usable intercept drones 104 according to any instructed order and/or flight pattern. Thereafter, the resource control unit 306, via the communications unit 308, instructs (Step 408) the selected re-usable intercept drones 104 to launch and fly to the location provided as per the instructions received.

The re-usable intercept drone or drones 104 fly to the location identified and using an on-board engagement system (not shown) supported by the on-board hardware of the re-usable intercept drone or drones 104, for example using radar or an optical imaging system, the re-usable intercept drone or drones 104 attempt to collide with the unauthorised UAV 106 in order to cause sufficient damage to the unauthorised UAV 106, for example to render the unauthorised UAV 106 incapable of flight. In the case of the single re-usable intercept drone 104, the re-usable intercept drone 104 communicates to the control system 102 when the re-usable intercept drone 104 has collided with the unauthorised UAV 106. In the case where multiple re-usable intercept drones 104 have been deployed, the re-usable intercept drones 104 are instructed via the drone coordination unit 302 and the resource control unit 306 to collide with the unauthorised UAV 106 in a coordinated manner, for example a choreographed manner, as will be described later herein in greater detail in relation to FIG. 6. The resource control unit 306 interrogates (Step 408) airborne drones in turn in order to obtain sensor data so that the drone health unit 304 can determine the flightworthiness (Step 410) of each airborne re-usable intercept drone 104 by way of receipt of data from each re-usable intercept drone 104 relating to the on-board sensors 240, 242, 244, 246 described above. Following advice from the re-usable intercept drone 104 that a collision has taken place and a determination (Step 410) that the re-usable intercept drone 104 that has been interrogated is airworthy, the drone coordination unit 302 determines (Step 412) whether the re-usable intercept drone 104 is required to attempt a further collision with the unauthorised UAV 106 owing to the unauthorised UAV 106 remaining flight capable. In the event that a further collision is required, the drone coordination unit 302 via the resource control unit 306 instructs the re-usable intercept drone 104 to attempt another collision with the unauthorised UAV 106. However, in the event that a repeat collision is not required, the drone coordination unit 302 determines (Step 414) whether a new target needs to be intercepted. If a new target needs to be intercepted, the drone coordination unit 302 via the resource control unit 306 communicates (Step 416) a new target destination to the re-usable intercept drone 104 along with an instruction to collide with the new target. In the event that the drone coordination unit 302 does not have a new target for the re-usable intercept drone 104 to intercept, the resource control unit 306 instructs (Step 418) the re-usable intercept drone 104 to land in a predetermined location, the resource control unit 306 providing the coordinates of the predetermined location. Following either instructing the re-usable intercept drone 412 to repeat a collision with the unauthorised UAV 106, a fresh collision with the new target, or to land (Step 418), the resource control unit 306 determines (Step 426) whether more airborne drones 104 need to be interrogated in order to determine their respective flightworthiness.

When the re-usable intercept drone 104 is determined (Step 410) not to be airworthy, which can include having insufficient electrical power remaining to remain airborne for sufficient time, the drone health unit 304 determines (Step 420) whether the re-usable intercept drone 104 is capable of landing at the predetermined location. In the event, that the re-usable intercept drone 104 is determined to be capable of landing at the predetermined location, the re-usable intercept drone 104 is instructed (Step 422) to land at the predetermined location, otherwise the re-usable intercept drone 104 is instructed (Step 424) to execute a controlled descent if possible.

Once the re-usable intercept drone 104 has been interrogated and provided with appropriate instructions, the resource control unit 306 determines (Step 426) whether other airborne re-usable intercept drones 104 require interrogation and if other re-usable intercept drones 104 require interrogation the above-described steps are repeated (Steps 408 to 426).

Referring back to the determination (Step 404 of FIG. 5) as to whether a single or multiple re-usable intercept drones 104 are required to render the unauthorised UAV 106 incapable of flight, so-called “swarm engagement” where more than one re-usable intercept drone 104 is required will now be described with reference to FIG. 6.

Following determination (Step 404) that swarm engagement is required, the drone coordination unit 302 selects (Step 500) a predetermined engagement pattern for the selected re-usable intercept drones 104 to follow. In this regard, the engagement pattern can comprise an order of attempted collision of the drones with the unauthorised UAV 106, as well as other aspects of a coordinated interception, for example direction of approach, and indeed exact flight path followed by selected re-usable intercept drones. The drone coordination unit 302 then selects (Step 502) the re-usable intercept drones 104 to participate in the exercise or mission from available re-usable intercept drones 104.

The drone coordination unit 302, in cooperation with the resource control unit 306, then provides (Step 504) intercept data, for example location, path to follow and/or speed to the selected re-usable intercept drones 104, and the selected re-usable intercept drones 104 are instructed (Step 506) to launch in the order conforming to the predetermined engagement pattern selected. The drone coordination unit 302 in cooperation with the drone health unit 304 then determines (Step 508) the statuses of the airborne re-usable intercept drones 104 involved in the interception of the unauthorised UAV 106, for example to ascertain the flight worthiness of the airborne re-usable intercept drones 104 with respect to availability for continued operation. The drone coordination unit 302 then determines (Step 510) whether the unauthorised UAV 106 has been rendered incapable of flight. In the event of the unauthorised UAV 106 is no longer airborne, the drone coordination unit 302 provides (Step 512) further instructions to the available re-usable intercept drones 104, for example to land at the predetermined location or intercept a new target as described above. If the unauthorised UAV 106 remains airborne, the drone coordination unit 302 determines (Step 514) whether any re-usable intercept drones 104 are available, either airborne or unlaunched. In the event that all the available re-usable intercept drones 104 are spent, then the intercept exercise/mission with respect to the unauthorised UAV 106 cannot continue. However, if one or more re-usable intercept drones 104 remain available, the drone coordination unit 302 updates (Step 516) instructions to the remaining re-usable intercept drones 104 to continue the intercept exercise with respect to the unauthorised UAV 106 and the above steps are repeated (Steps 510 to 516) until the unauthorised UAV 106 no longer remains airborne or all the available re-usable intercept drones 104 are spent.

The skilled person should appreciate that the above-described implementations are merely examples of the various implementations that are conceivable within the scope of the appended claims. Indeed, it should be appreciated that although in the above examples the drones are airborne drones, the above examples apply equally to other unmanned vehicles, for example underwater vehicles. Whilst in the above examples, the drone coordination unit 302 employs a predetermined engagement pattern, the drone coordination unit 302 can employ an adaptive machine learning-based engagement system to collide one or more re-usable intercept drones 104 with the unauthorised UAV 106. Although in the above examples, the coordination of the collision with the unauthorised UAV 106 is performed by the control system 102, in order examples, the re-usable intercept drones can be capable of communicating with each other and coordination at least part of the collision exercise on a peer-to-peer basis.

What is claimed is:

1. A re-usable intercept drone comprising:
an elongate fuselage;
a first wing and a second wing operably coupled to the elongate fuselage and extending substantially away from the elongate fuselage;
a first propulsion unit and a second propulsion unit operably coupled to the first wing and the second wing, respectively; and
a third propulsion unit and a fourth propulsion unit operably coupled to the fuselage; wherein
the first, second, third and fourth propulsion units are circumferentially spaced about the elongate fuselage.

2. The drone according to claim 1, wherein at least one of the first, second, third and fourth propulsion units is a ducted fan propulsion unit.

3. The drone according to claim 1, wherein at least one of the first, second, third and fourth propulsion units is a shrouded prop propulsion unit.

4. The drone according to claim 1, further comprising:
a plurality of leading edges relative to an intended direction of travel; wherein
a number of the plurality of leading edges are reinforced.

5. The drone according to claim 4, wherein the fuselage comprises a nose cone portion, the nose cone portion comprising a reinforcement structure.

6. The drone according to claim 5, wherein the nose cone comprises a ram constituting the reinforcement structure.

7. The drone according to claim 4, wherein the reinforcement is material-based.

8. The drone according to claim 4, wherein the reinforcement is a coating of a material.

9. The drone according to claim 1, further comprising:
a plurality of sensor modules configured to generate a plurality of data;
a processing resource; wherein
the plurality of sensor modules is operably coupled to the processing resource and the processing resource is configured to detect damage sustained by the drone in response to one or more data received from one of more of the plurality of sensors, respectively.

10. A drone engagement system comprising:
a plurality of re-usable intercept drones according to claim 1; and
a control system; wherein
the control system is configured to communicate with the plurality of re-usable intercept drones, and the plurality of re-usable intercept drones is configured to communicate with the control system;
the control system is configured to receive an identity of a target;
the control system is configured to plan one or more collisions of the plurality of intercept drones with the target; and
the control system is configured to communicate the identity of the target and a location to the plurality of re-usable intercept drones in accordance with the planned one or more collisions.

11. The drone engagement system according to claim 10, wherein the control system is configured to coordinate the one or more collisions of a number of the plurality of intercept drones with the target.

12. The drone engagement system according to claim 10, wherein the control system is configured to choreograph the one or more collisions of a number of the plurality of intercept drones with the target.

13. A drone engagement system comprising:
a re-usable intercept drone according to claim 1; and
a control system; wherein
the control system is configured to communicate with the re-usable intercept drone, and the re-usable intercept drone is configured to communicate with the control system;
the control system is configured to identify a target to the re-usable intercept drone and instruct the re-usable intercept drone to collide with the target.

14. The system according to claim 13, wherein the control system is configured to interrogate the re-usable intercept drone to determine a degree of flightworthiness of the re-usable intercept drone after an attempted collision of the re-usable intercept drone with the target.

15. The system according to claim 14, wherein the control system is configured to identify another target to the re-usable intercept drone in response to the degree of flightworthiness being acceptable to continue missions, and to instruct the re-usable intercept drone to collide with the another target.

16. The system according to claim 13, wherein the control system is configured to instruct the re-usable intercept drone to land at a predetermined location in response to the degree of flightworthiness being unacceptable to continue missions.

17. A method of colliding a re-usable intercept drone with a target, the method comprising:
a control system communicating an identity of the target to the re-usable intercept drone; and
the control system instructing the re-usable intercept drone to collide with the target.

18. The method according to claim 17, wherein
the re-usable intercept drone attempts to collide with the target;
the control system communicates with the re-usable intercept drone to determine a degree of flightworthiness of the re-usable intercept drone after the attempted collision.

19. The method according to claim 18, further comprising:
the control system communicating an identity of another target to the re-usable intercept drone in response to the degree of flightworthiness being acceptable to continue missions.

20. The method according to claim 18, further comprising:
the control system instructing the re-usable intercept drone to land at a predetermined location in response to the degree of flightworthiness being unacceptable to continue missions.

21. A method of controlling engagement of a plurality of re-usable intercept drones with a target, the method comprising:
a control system receiving an identity of a target;
the control system planning one or more collisions of the plurality of re-usable intercept drones with the target; and
the control system communicating the identity of the target and a location thereof to the plurality of re-usable intercept drones in accordance with the planned one or more collisions.
